(19) United States
(12) Patent Application Publication
(10) Pub. No.: US 2017/0153708 A1
(43) Pub. Date: Jun. 1, 2017

(54) Secured and Noise-suppressed Multidirectional Gesture Recognition

(71) Applicants: Tusher Chakraborty, Dhaka (BD); Md. Taksir Hasan Majumder, Comilla (BD); Sakib Md Bin Malek, Dhaka (BD); Md. Nasim, Dhaka (BD); Md. Samiul Saeef, Dhaka (BD); A. B. M. Alim Al Islam, Dhaka (BD)

(72) Inventors: Tusher Chakraborty, Dhaka (BD); Md. Taksir Hasan Majumder, Comilla (BD); Sakib Md Bin Malek, Dhaka (BD); Md. Nasim, Dhaka (BD); Md. Samiul Saeef, Dhaka (BD); A. B. M. Alim Al Islam, Dhaka (BD)

(21) Appl. No.: 14/953,369

(22) Filed: Nov. 29, 2015

(51) Int. Cl. G06F 3/01; G06F 3/0481; G06F 3/16; G06F 3/03

(52) U.S. Cl. CPC G06F 3/017; G06F 3/0308; G06F 3/0481; G06F 3/16

(57) ABSTRACT

The subject matter disclosed herein relates to detecting unidirectional or multidirectional movement(s) or gesture(s) made by moving object(s). Aspects of the disclosure pertain to a system and method for mining real-time deviation in illuminance of light reflected off moving object(s) to detect movement(s) or gesture(s) made by the moving object(s). The system contains a singular or a plurality of coupling(s), each consisting a light source and a light sensor unit pair, arranged in a specific spatial configuration directing towards single or multiple direction(s) along with a computational unit. The method performs individual noise elimination over data collected in temporal domain by each coupling to enable the system to perform under any lighting conditions and any external noises. Besides, mapping between gesture(s) and corresponding input signal(s) can be varied dynamically leading towards a highly-secured system that will be extremely difficult to break through eavesdropping or any other security threats attempted by outsiders.

### FIELD OF THE INVENTION

The present invention relates to a method and design of a system that detects simple or complex gestures performed in one or multiple directions in any lightning condition, with enhanced security measures, using a single or a plurality of coupling(s) each comprising a light source and a light sensor.

### BACKGROUND OF THE INVENTION

Ubiquitous electronic devices such as laptops, smartphones, tablets, etc., have become unavoidable parts of contemporary modern lives and are expected to remain so in future. Most of the devices are designed with a capability of taking touch-based inputs from their users. Few recent technologies have also empowered the users to use other methodologies such as using voice commands for providing inputs. However, very few high-resource devices allow such voice commands. Consequently, bulk of user interactions still rely on touch-based inputs.

Touch-based interactions with different input devices such as keyboards of laptop, keypads in ATMs, touchpads of smartphones etc., may pose problems related to touch-based contamination. For example, in clinical situations, it is imperative to reduce physical contact with devices as much as possible in order to control cross-contamination and other similar problems. Therefore, a device designed to take touch-based inputs may present risks of health hazards to its users. A touchless input detection system can be a remedy to such problems, since it requires no physical contact from a user to operate. Additionally due to mostly being fixed in nature, touch-based inputs can easily be copied by potential malicious or harmful outsiders, thus its security vulnerabilities exist.

A touchless system allows a user to perform gestures, which are mapped to predefined input signals. A gesture can be as simple as waving one's hand from one side to another, whereas, it can be as complex as simultaneously using multiple fingers moving in different directions. Capability of detecting gestures from several directions increases the number of alternate gestures that can be recognized.

Touchless input systems can rely on properties of reflected light. Lighting conditions can severely affect the efficiency of such touchless input systems. At the extreme, the systems may completely fail with varying lighting conditions. For example, such a system performs poorly while being operated during daytime under the sun. Consequently, the intensity of light present in the environment is an important aspect that exhibits significant influence over the operation of such systems. Therefore, a touchless system, having the capability of eliminating noises at any lighting condition will operate much more reliably than a conventional touchless system.

Using a touchless system, having a fixed mapping between gestures and input signals has a risk of being tracked by potential malicious or harmful outsiders, who are likely to remember the gestures performed to input confidential data, such as passwords. Since gestures are usually performed using body parts or some hand-held objects that are generally big enough to be detected visually, such risks involved with touchless systems having the fixed mapping is mostly unavoidable. Therefore, eliminating such risks is also crucial for designing a secured touchless system.

### SUMMARY OF THE INVENTION

The above mentioned problems are tackled through using a singular or a plurality of coupling(s) each consisting a light source and a light sensor, oriented in the same or different directions. Only visible light sources are used, which continuously emit energy over the visible light spectrum. Each light source is positioned near its coupled sensor facing in the same direction. The light sources may be of any visible color such as white, blue, red, etc.

The light sensor of a coupling detects motion within a particular region with the help of its coupled light source. Each light source generates individual signal based on the motion or gesture made in front of it. When a plurality of couplings are used together, it is possible to detect gestures performed in multiple directions.

The basic working principle of the system relies on capturing the variation in illuminance of light reflected from a moving object having the reflective property. All real reflector objects reflect light towards different angles and thus, can be modeled as lambertian reflectors. A lambertian reflector object provides uniform diffusion of its incident radiation such that its luminance remains same in all directions from which it can be measured. On the other hand, illuminance of light at a point is inversely proportional to the square of the direct distance between that point and corresponding light source. Now, when a gesture is performed, the performing body (for example, hand, fingers, gloves, etc.) or object changes its distance with respect to one or multiple of the coupling(s). Here, light emitted from the light sources gets reflected off the gesture performing object. A part of the reflected light falls upon the sensor, which can detect the change in illuminance of the reflected light. As the gesture performing object changes its position, the illuminance of the reflected light also varies. This variation is actively identified by the sensor(s) in real time and signal(s) generated by the sensor(s) also changes accordingly.

Our system monitors real-time deviation of illuminance of reflected light. Analyzing the real-time deviation, it decides if any pre-specified gesture(s) has been performed. For example, in case of performing an inbound gesture through moving an object towards a coupling, the illuminance of the reflected light fallen upon the sensor of the approached coupling gets increased with the progression of time. As a result, strength of the signal generated by the sensor also gets increased accordingly. Hence, there occurs a certain trend in real-time deviation over the signal generated by the sensor. Analyzing this certain trend in real-time deviation, the system confirms that the particular inbound gesture has been performed. Consequently, operation of our system is completely independent of any comparison to a threshold value, which is the basis of most of the conventional gesture detection systems. Such already-proposed gesture detection systems rely on monitoring if a threshold value has been reached or not by the absolute value of the signal generate by a sensor to detect a gesture. On the contrary, our system does not monitor the absolute value of the signal generated by the sensor (i.e., the absolute measure of illuminance of the reflected light), rather it takes into account the notion of real-time deviation over signal generated by the sensor. Therefore, one of the significant novelties of our system lies in its underlying operational mechanism as it relies upon revealing the trend in real-time deviation of perceived data, instead of relying upon the conventional approach of establishing and utilizing a particular threshold value for comparing the absolute value of the real-time data.

Our system can consist of a single or a plurality of couplings. In case of having a plurality of couplings, the couplings can be faced in multiple directions to detect multidirectional gestures. In order to check if any such gesture has been performed, our system simultaneously analyzes signals from all the couplings.

An example of a simple unidirectional gesture is moving one's hand towards one of the couplings of our system. When such a simple gesture is performed in front of the sensors of the approached coupling, a strong signal is generated by the sensor. Here, sensor(s) of other coupling(s) may also generate negligible or no signal. Consequently, through identifying a significant trend in the real-time deviation over the signal of a single sensor, the unidirectional gesture can be detected. The system can also detect complex gestures. Examples include, moving user's hand diagonally towards a direction in between two couplings, moving fingers in front of two couplings at the same time, etc. In such cases, the approached two couplings generate strong signals, whereas other couplings generate negligible or no signal at all. Additionally, relative angle of direction for a simple gesture with respect to nearest couplings differs to that for a complex gesture. As a result, the real-time deviations over the generated signal will also differ for both the types of gestures. Consequently, the complex gestures can be detected through identifying a completely different trend in the real-time deviation over the signals generated by sensors of the approached couplings.

As visual light is pervasive, the task of eliminating significant diversified noises has to be considered with utmost importance. Moreover, our system operates with gestures and people cannot be resisted from generating different non-specified gestures such as moving hands or objects unintentionally around the system in random directions. Such unintentional random gestures introduce yet another dimension in experiencing noises. Furthermore, we have to work with several lighting conditions and the lighting conditions could be changed even at the time of performing gestures. Nonetheless, a prominent disadvantage of the conventional systems operating in similar environment and conditions is that they rely on a threshold value of sensed data during the operation. Consequently, they have to deal with noise cancellation using costly infrastructures or safeguards owing to the already-mentioned fact that, the ambient lighting condition may change at anytime. Nevertheless, the notion of enabling a threshold values for detecting gestures does not work robustly in such cases. It happens as the threshold value itself demands of being recalculated, which exposes a significant limitation of conventional visible light based gesture detection systems while operating in different ambient light conditions. Our system is free from such limitations, because it does not depend on any threshold value of sensed data during its operation. Rather, it utilizes real-time deviation over the sensed data resulted from the change in illuminance of the reflected light. The utilization of real-time deviation retains the detection process robust under different lighting conditions. This is achieved through considering the fact that an abrupt change in ambient light condition (such as switching the room light on or off) deviates the illuminance of light very fast within a very small period of time by a significant margin. Such short-lived high-valued deviations get identified and subsequently eliminated by our system. On the contrary, our system retains considerably long-lived real-time deviations, as a longer period of time is generally needed to perform a gesture by a human. Additionally, our system ignores any real-time deviation that has not been made familiar with earlier. Thus, any unintentional movement of objects around the system, which does not result in any of the pre-specified real-time deviations in general, also get identified and subsequently eliminated by our system.

There exists a security risk associated with gesture-based touchless input systems. Here, as the the gestures are being made by widely visible object such as hands, the gestures generally remain noticeable in public. Consequently, gestures made for operating such systems can be exposed in danger of being imitated by outsiders, who want to crack a user's private data through imitating the gestures performed by the user. As a remedy to this scenario, our system can dynamically change the mapping between performed gesture and corresponding input signal periodically. Here, the current mapping can be presented to a user through any type of presentation unit such as a visible layout, audible instructions, etc. The mapping can evolve over time through being any function of time, the number of inputs given, or the number of gestures performed, etc. The mapping can be a random function too. Alternatively, the mapping can also be a combination of the function and randomization. In case of adopting any such dynamic mapping, it will be really difficult for an outsider or an unwanted person to trace input(s) of another user through only visually observing the gesture(s) owing to the run-time change in mapping between gestures and corresponding input signal.

### BRIEF DESCRIPTION OF THE DRAWINGS

The system is illustrated in the way of a developed real system and its operation.

FIG. 1 presents a block diagram of the overall system operation.

FIG. 2 presents the drawing of multiple couplings along with an operation towards a single coupling.

FIG. 3 shows four simple unidirectional gestures performed towards the system through exploiting single source-sensor coupling for each gesture.

FIG. 4 shows four more gestures towards the system through exploiting two adjacent source-sensor couplings for each gesture.

FIG. 5 shows two more complex gestures towards the system through exploiting two non-adjacent source-sensor couplings for each gesture.

FIG. 6 presents two different mappings between pre-specified gestures and corresponding input signals.

FIG. 7 presents a flowchart of the underlying mechanism of our system including its methodology adopted for noise elimination.

### DETAILED DESCRIPTION OF THE DRAWINGS

In the following description, we are going to explain the underlying construction, methodology, and detail operation of the system.

Our proposed system consists of two different modules: hardware and software modules. The hardware module deals with all external interaction with user and real data collection. The software module deals with necessary data processing and other internal processing.

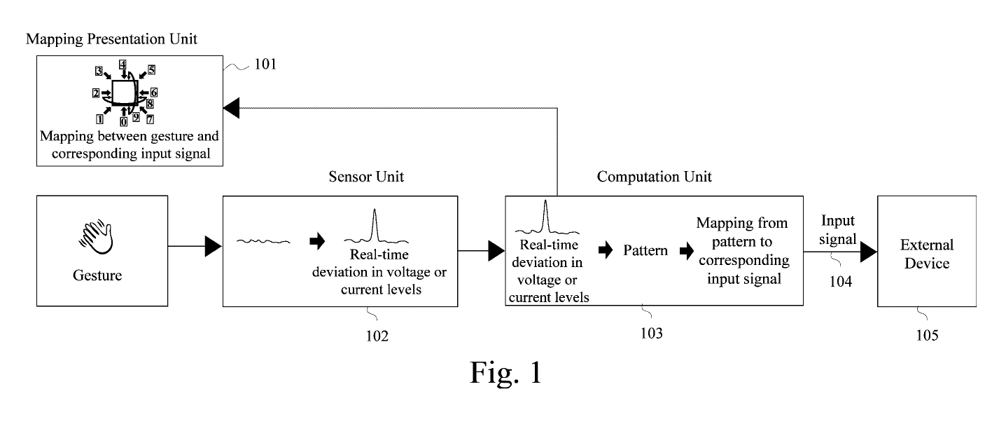

In FIG. 1, we present a simplified block diagram of the underlying operational mechanism of our system. The system consists of three units: (1) Mapping presentation unit 101, (2) Sensor unit 102, and (3) Computational unit 103. The moving object(s) need to be moved according to the gesture-input signal mapping presented through the Mapping presentation unit 101. The Sensor unit 102 contains a singularity or a plurality of coupling(s), each containing a light source and a light sensor. Function of the Sensor unit is to emit light and sense illuminance of the light incident upon it including the light reflected from nearby moving objects (e.g., hand or any other suitable object that can reflect light). The Computation unit 103 collects signals generated by the sensor unit in response to gesture(s) and processes them for detecting pre-specified gesture(s) after being performed. Then, it generates input signals 104 as an input device and feeds that to connected external device(s) 105. Examples of the input device include, but not limited to, ATM number pad, keyboard, joystick, and any other similar devices that generate signals to operate other devices. The Computation unit also determines mapping between pre-specified gesture(s) and input signal(s) and presents it to the user through the Mapping presentation unit 101. Examples of the presentation unit include, visible layouts, audible instructions provider, etc.

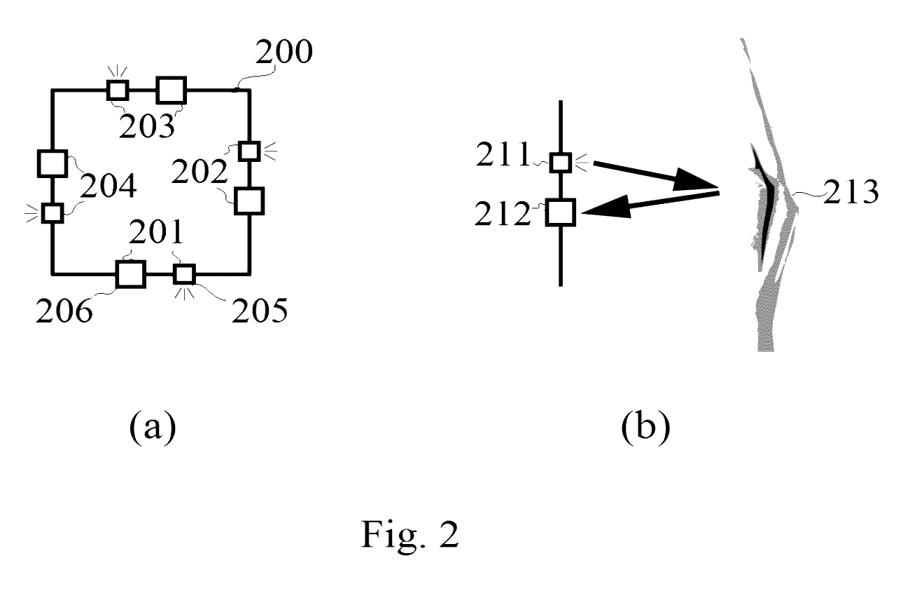

FIG. 2(a) shows a drawing of the whole sensor unit. It consists of four couplings 201, 202, 203, and 204, each having a light source and a light sensor placed on a small board 200. The number of couplings can vary based on different considerations, for example, the number and complexity of pre-specified gestures, space, and user interactive design. Additionally, the position of couplings can vary according to the similar considerations. To detect multidirectional gesture(s), one can use single or multiple couplings in single or multiple directions. Each coupling has a light source 205. The light source can be of any color and suitable size. One example of the light source can be LED. Alongside, there is a light sensor 206 with each light source facing at the same direction. This light sensor can be any sensor capable of sensing visible light such as photodiode, phototransistor, LDR, etc.

In FIG. 2(b), we present a possible gesture performed towards our system. Here, we show a coupling of light source 211 and light sensor 212 facing at the same direction as the part of our system. A hand 213 (or any other object having the reflective property) is moving in front of the coupling. The moving object can be of any color. Light emitting from the light source gets reflected from the hand and the reflected light is received by the sensor. The sensor generates signal based on the illuminance of light captured by the sensor after being reflected off the moving object, i.e., hand. The moving object can be of any color. The object, i.e., hand, needs to move within a certain area in front of source-sensor coupling. The size of this area depends on the selection of light source and sensor in operation. Therefore, it remains a design issue. Besides, the real-time processing of the signals generated by the sensor(s) is explained later.

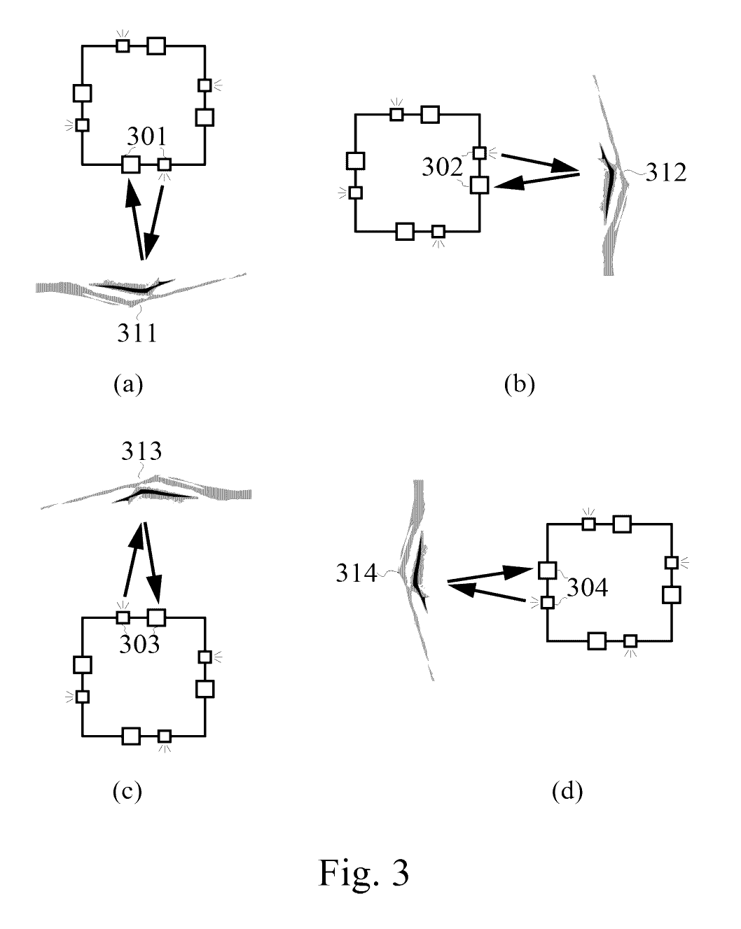

FIG. 3 shows four simple gestures that can be detected by our system. In FIG. 3(a), a hand 311 moves towards the source-sensor coupling 301. This movement results in a real-time deviation over signal generated by the sensor of the coupling 301 due to a change in illuminance of the light reflected from the moving hand. The remaining three gestures are similarly performed by a moving hand towards corresponding source-sensor couplings. In FIGS. 3(b), 3(c), and 3(d), the three gestures are performed by moving hands 312, 313, and 314 towards couplings 302, 303, and 304 respectively.

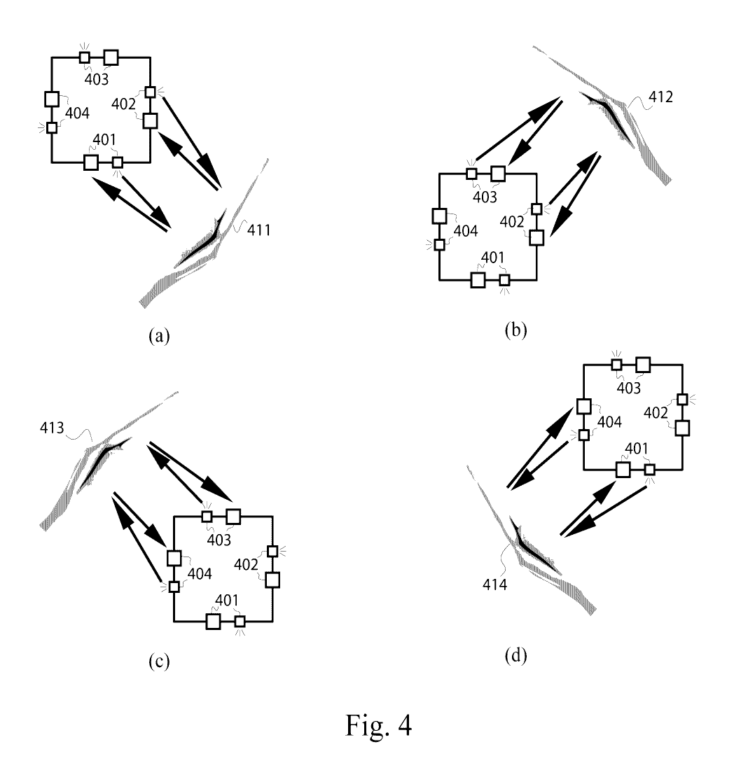

FIG. 4 shows four more gestures, which can be detected by our system. In these cases, the hand moves diagonally between two light-sensor couplings. Such movements result in real-time deviations over the signals generated by two sensors at the same time. On the contrary, in case of the previous four gestures, each of the gestures results in a real-time deviation over the signal of only one sensor. Moreover, another important aspect is that the diagonal gestures do not result in same deviation over the signals generated by the two sensors that capture the effect of the diagonal movements. This happens as the illuminance of light reflected off the hand is more in case of the previous four gestures due to having a difference in angles between the direction of the orientation of the coupling(s) and the direction of movement made by moving hand. In FIG. 4(a) the hand 411 moves diagonally between couplings 401 and 402. Therefore, this movement is detected by sensors of the couplings 401 and 402. Gestures shown in FIGS. 4(b), 4(c), and 4(d) follow the same mechanism. In FIG. 4(b), the hand 412 moves between the couplings 402 and 403. In FIG. 4(c), the hand 413 moves between the couplings 403 and 404. In FIG. 4(d), the hand 414 moves between the couplings 401 and 404.

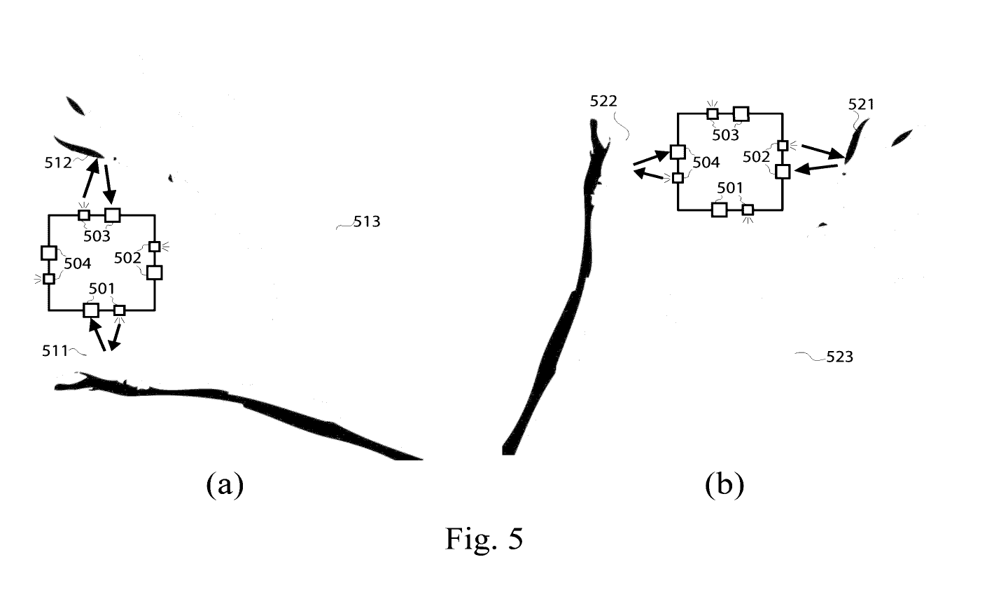

FIG. 5 shows two more complex gestures, which can also be detected by our system. Here, the user uses his/her fingers of hand 513 to move in front of two non-adjacent source-sensor couplings, which are in opposite directions to each other. In FIG. 5(a), the fingers 511 and 512 of the user move in front of the couplings 501 and 503. Here, the illuminance of light reflected from the fingers and subsequently sensed by the sensors of both couplings 501 and 503 changes at the same time. Consequently, the movement of the fingers results in real-time deviation over signals generated by the two sensors of couplings 501 and 503 at the same time. Gesture shown in FIG. 5(b) follows the same mechanism. In FIG. 5(b), fingers 521 and 522 of the user's hand 523 move in front of the couplings 502 and 504 respectively. These movements result in real-time deviation over signals generated by the two sensors of couplings 502 and 504 at the same time.

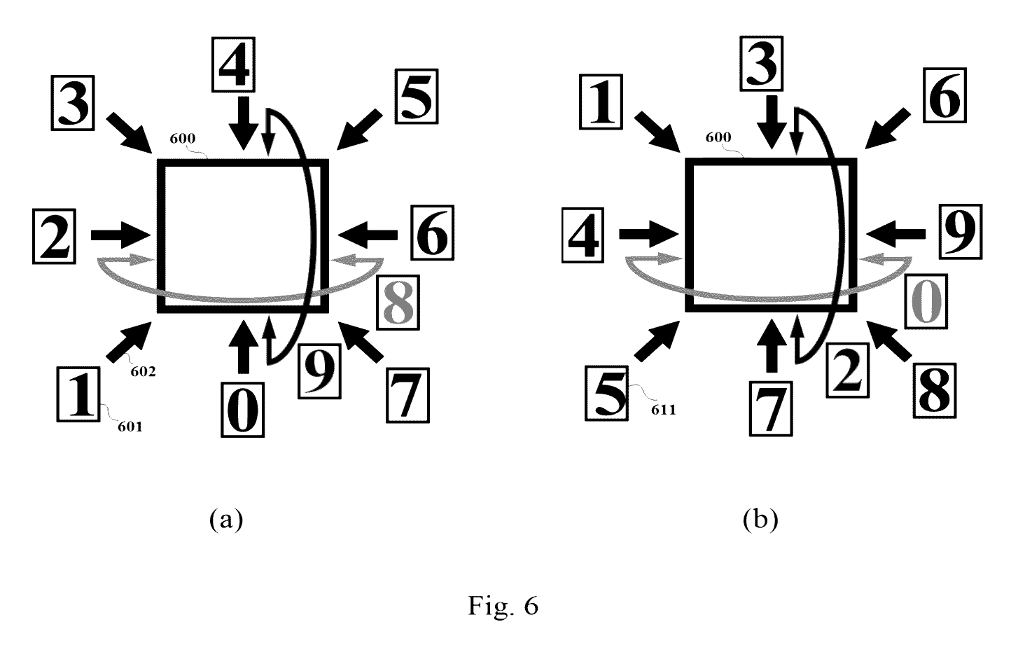

In FIG. 6, two drawings depicting two possible mappings between pre-specified gestures and corresponding input signals are shown pertinent for the system. There can be many more different combinations of such mapping. A user can perform the depicted pre-specified gesture(s) in order to generate intended input signals from the system. There are ten different gestures presented in each drawing of FIG. 6. An example application of the system with the mapping can be a connection to a computer as a number pad. Here, numbers from 0 to 9 are mapped to ten different gestures as shown in FIG. 6(a). The gestures are presented around a unit 600 comprising both light sources and sensors as shown in FIG. 2(a). The mapping can be static or dynamically determined by the Computation unit of the system. An example mapping is presented in FIG. 6(a), where both gestures and corresponding signals are shown. Here, the arrow 602 shows a gesture and the digit “1” appeared in the block 601 shows the corresponding input signal that will be generated if a gesture following the arrow 602 is made. This mapping between gesture(s) and corresponding input signal(s) can be generated in a static manner or through exploiting a function or through being purely random or using any combination of these approaches. If the mapping gets changed following a dynamic approach, the positions of digits pertinent for input signals (as shown in FIG. 6(a)) also get changed. FIG. 6(b) shows another mapping that could appear after the changes take effect. Here, the block 611 presents digit the “5”, which was digit “1” in the previous mapping.

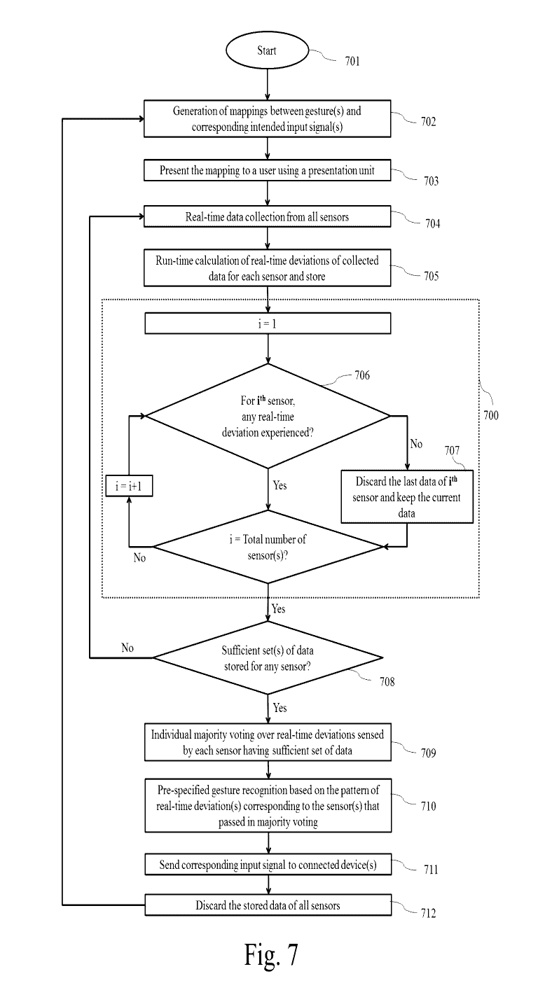

FIG. 7 presents a flowchart of the underlying mechanism of our system. The mechanism consists of four sequential tasks—mapping generation, sensor data collection, noise elimination, and gesture detection. At the very beginning, the system is powered on and the light sources generate light beams in Step 701. In Step 702, the Computation unit generates a mapping between gestures and corresponding input signals based on one of the methodologies stated above. This mapping can be generated after performing each gestures or a sequence of gestures. In the next Step 703, the computation unit presents the generated mapping to users through one of the methodologies stated above.

In Step 704, real-time data of each sensor's output is collected and stored in memory. Subsequently, analog data is converted to digital data using ADC. If at least two sets of the data are collected for any one of the sensors, the mechanism moves to Step 705.

In Step 705, Computation unit individually calculates real-time deviations over the sets of data collected from each sensor and saves them in memory.

Block 700 is a for-each loop over all sensors. It enables a loop of operations for all sensors. In Step 706, recently-calculated deviations corresponding to each sensor are checked. There could be two cases for each sensor. (Case-1) Real-time deviation is not experienced. This happens when no gesture is performed towards the corresponding sensor. If Case-1 occurs for any sensor, the mechanism goes to Step 707. In Step 707, the Computation unit discards the earlier data and current deviation, and keeps the recent data of that sensor. After taking similar actions for each sensor germane to Case-1, the Computation unit goes to Step 708. (Case-2) Real-time deviation is experienced. If Case-2 occurs for any of the sensors, the mechanism skips Step 707 for that sensor.

In Step 708, computation unit checks for the number of data sets stored corresponding to each sensor. If it reaches to a predefined data storage margin for any sensor, computation unit goes to Step 709. If the number of data sets stored is less than the data storage margin for all sensors, the mechanism continues data collection from Step 704.

Step 709 deals with the sensor(s), which possesses a data set having an equal size of data storage margin. In this step, the computation unit eliminates noises such as, undesired movements or gesture(s) nearby the sensor unit, abrupt change in lighting condition, etc. Here, the mechanism uses majority voting. Majority voting is applied over the set of real-time deviations sensed by each sensor that qualifies for Step 709. As an abrupt change can have very short-lived effect resulting a real-time deviation over only a few data sensed by a sensor. Therefore, this situation does not pass in majority voting criteria. Besides, noises at distant make insignificant changes resulting no or a small number of meaningful real-time deviations over the sensed data.

Step 710 deals with the sensor(s), which have/has passed in majority voting. In this step, the mechanism classifies pre-specified gestures based on identifying patterns over the real-time deviations. For example, if two adjacent sensors pass in majority voting and exhibit the same real-time deviation pattern, then a diagonal gesture (as described in FIG. 4) can be confirmed.

In Step 711, the computation unit generates an input signal corresponding to the gesture performed following the mapping presented in Step 703. The generated signal is fed to connected external device(s).

In the final Step 712, the Computation unit discards all stored data and real-time deviations sensed by the sensors, and then gets back to Step 702 again.

What is claimed is:

1) A system comprising:
a single or a plurality of coupling(s) each having a light source and a light sensor, where each coupling is directed towards the same or different direction(s);
each light source continuously radiates energy over the visible light spectrum;
each light sensor generates signal according to illuminance of the light incident upon it, after the light being reflected from one or multiple moving object(s);
a computational unit connected with coupling(s) for detecting gesture(s) of moving object(s) using real-time deviation over signal(s) generated by the sensor(s).

2) The system of claim 1, wherein:
the computational unit uses real-time deviation over signal generated by the sensor of a single coupling to detect unidirectional gestures of a moving object;
the computational unit uses real-time deviations over signals generated by the sensors of multiple couplings directed in single or multiple direction(s) to detect multidirectional gestures of moving object(s).

3) The system of claim 2, further comprising working capability in any sort of indoor or outdoor lighting conditions such as dark, dim lit, room light, shaded sunlight, bright sunlight, and even in extreme conditions of having focused light ray towards the system.

4) The system of claim 2, further comprising perfect working capability in the presence of any kind of external noise(s) such as random movements of moving object(s) in close proximity or movements of moving object(s) at distance, single or multiple moving external light source(s), and varying illuminance of single or multiple external light source(s).

5) The system of claim 1, wherein either one or both of the object(s) and light source(s) can be of any color(s).

6) The system as recited in claim 1, wherein the object can comprise user's hand(s), finger(s), glove(s), or any other object having the reflective property.

7) The system of claim 2, further comprising identifying pre-specified gesture(s) and considering each of them as an intended input signal mapped to that gesture.

8) The system as recited in claim 7, wherein the mapping from intended input signals to pre-specified gestures can be static or dynamic.

9) The system as recited in claim 8, wherein the dynamic mapping can be a function of any natural phenomena such as time, the number of inputs given, the number of gestures performed, etc., or a randomized function.

10) The system as recited in claim 8, wherein the mapping can be exposed to a user through any type of presentation unit such as visible layout(s), audible instruction(s), etc.

11) The system as recited in claim 7, further comprising identifying any gesture, which is not included in the pre-specified gesture(s) set, as an undefined gesture.

12) The system of claim 7, wherein generating signals according to identified gestures can mimic any type of device(s) covering ATM number pad, keyboard, mouse, joystick, and any other similar input device.
